(19) United States
(12) Patent Application Publication
(10) Pub. No.: US 2013/0033113 A1
(43) Pub. Date: Feb. 7, 2013

(54) PHOTOVOLTAIC SYSTEMS WITH VOLTAGE BALANCERS

(71) Applicants: Gui-Song Huang, Shanghai (CN); Ya-Hong Xiong, Shanghai (CN); Jie Huang, Shanghai (CN)

(72) Inventors: Gui-Song Huang, Shanghai (CN); Ya-Hong Xiong, Shanghai (CN); Jie Huang, Shanghai (CN)

(73) Assignee: DELTA ELECTRONICS (SHANGHAI) CO., LTD., Shanghai (CN)

(21) Appl. No.: 13/251,733

(22) Filed: Oct. 3, 2011

(30) Foreign Application Priority Data
Aug. 3, 2011 (CN) 201110221423.2

(51) Int. Cl. H02J 1/00

(52) U.S. Cl. 307/77

(57) ABSTRACT

A photovoltaic module includes N sub-modules electrically connected to each other such that the negative terminal of any one but the last sub-module is electrically connected to the positive terminal of the immediate next sub-module, and N−1 voltage balancers, each having a first terminal, a second terminal and a third terminal. The second and third terminals of any one but the last voltage balancer are electrically connected to the third and first terminal of the immediate next voltage balancer, respectively. The first terminal of the first voltage balancer is electrically connected to the positive terminal of the first sub-module. The second terminal of the last voltage balancer is electrically connected to the negative terminal of the last sub-module. The third terminal of the j-th voltage balancer is electrically connected to both the negative terminal of the j-th sub-module and the positive terminal of the (j+1)-th sub-module.

### CROSS-REFERENCE TO RELATED PATENT APPLICATION

This application claims priority to and the benefit of, pursuant to 35 U.S.C. §119(a), Chinese patent application No. 201110221423.2, filed Aug. 3, 2011, entitled “PHOTOVOLTAIC SYSTEMS WITH VOLTAGE BALANCERS”, by Gui-Song Huang, Ya-Hong Xiong and Jie Huang, the content of which is incorporated herein by reference in its entirety.

### FIELD OF THE INVENTION

The present invention relates to a photovoltaic system, and more particularly, to a photovoltaic system that utilizes one or more voltage balancers to balance the output voltages of photovoltaic modules or sub-modules thereof.

### BACKGROUND OF THE INVENTION

Photovoltaic (PV) modules are increasingly used to generate electrical energy from energy of sunlight incident on solar cells. Typically, a PV module is formed with a plurality of solar cells 10 connected in series, which may be grouped into a number of sub-modules 20 connected in series. For example, as shown in FIG. 10, there are 3 sub-modules connected in series, and there are 18-20 solar cells connected in series in each sub-module. A PV system is formed by placing a number of PV modules in series in a string and sometimes by placing multiple strings of in-series-connected PV modules in parallel, depending on the desired output voltage and power range of the PV system. In practices, differences exist between output powers of individual solar cells 10 in various sub-modules 20, e.g. due to the sub-modules being temporarily shaded, pollution on one or more solar cells, or even spread in solar-cell behavior that may become worse during aging.

Due to the current-source-type behavior of solar cells 10 and the fact that the value of the solar current per cell depends on the amount of incoming light, not all current sources connected in series inside the PV module may have the same value. In order to prevent that a current of a weakest cell determines the output current of the whole PV module, bypass diodes 30 are typically used inside the PV module. As shown in FIG. 10, each bypass diode 30 is connected to a respective sub-module 20 in parallel. Once one sub-module 20 is partially shaded, the bypass diode 30 in the sub-module 20 will be in a conduct state accordingly, and thus provides throughway for the module current Io.

However, the disadvantage of using bypass diodes is the related default-risk of the PV module and the fact that the module is not anymore reverse-polarity. The diodes can be destroyed by polarity.

Therefore, a heretofore unaddressed need exists in the art to address the aforementioned deficiencies and inadequacies.

### SUMMARY OF THE INVENTION

The present invention, in one aspect, relates to a photovoltaic (PV) module. In one embodiment, the module includes N sub-modules, N being an integer greater than one, each sub-module having a positive terminal and a negative terminal, the N sub-modules electrically connected to each other in series such that the negative terminal of any one but the last sub-module is electrically connected to the positive terminal of the immediate next sub-module.

The module also includes N−1 voltage balancers. Each voltage balancer having a first terminal, a second terminal and a third terminal, where the second terminal of any one but the last voltage balancer is electrically connected to the third terminal of the immediate next voltage balancer; the third terminal of any one but the last voltage balancer is electrically connected to the first terminal of the immediate next voltage balancer; the first terminal of the first voltage balancer is electrically connected to the positive terminal of the first sub-module; the second terminal of the last voltage balancer is electrically connected to the negative terminal of the last sub-module; and the third terminal of the j-th voltage balancer is electrically connected to both the negative terminal of the j-th sub-module and the positive terminal of the (j+1)-th sub-module, j=1, 2, 3, . . . , (N−1).

In one embodiment, each voltage balancer has a first switch, S1, and a second switch, S2, electrically coupled between the first terminal and the second terminal; a first diode, D1, and a second diode, D2, each diode electrically coupled to a respective switch in parallel; an inductor, L, electrically coupled between the junction of the first and second switches and the third terminal; and a first capacitor, C1, electrically coupled between the first and third terminals and a second capacitor, C2, electrically coupled between the second and third terminals.

Additionally, each voltage balancer may further include a pulse generator electrically coupled to the first and second switches S1 and S2 for providing one or more driving signals for driving the first and second switches S1 and S2, wherein the one or more driving signals have a compensative 50% duty cycle.

In one embodiment, each voltage balancer also has an enable logic circuit electrically coupled between the pulse generator and the first and third terminals, wherein the enable logic circuit is configured to sense input voltages V1 and V2 such that when the difference between input voltages V1 and V2 is lower than a predetermined threshold, the enable logic circuit disables the pulse generator and turn the voltage balancer off, wherein the input voltages V1 and V2 are voltages at the first and third terminals, respectively.

The PV module further includes a DC/DC converter having a positive input, a negative input, a positive output and a negative output, wherein the positive and negative inputs are electrically coupled to the positive terminal of the first sub-module and the negative terminals of the last sub-module, respectively. The DC/DC converter in one embodiment, includes a pair of switches electrically connected between the positive and negative terminals; an inductor electrically coupled between the positive output and the junction of the pair of switches; and a pair of capacitors, one capacitor electrically coupled between the positive and negative inputs, and the other electrically coupled between the positive and negative outputs, wherein the negative output is electrically connected to the negative input.

In one embodiment, each sub-module includes a plurality of PV cells electrically connected to each other in series.

In another aspect, the present invention relates to a PV system. The PV system in one embodiment includes a plurality of PV modules, each PV module defined above, the plurality of PV modules electrically connected to each other in series such that the negative terminal of any one but the last PV module is electrically connected to the positive terminal of the immediate next PV module.

The PV system also includes an inverter having a first input electrically connected to the positive terminal of the first PV module, a second input electrically connected to the negative terminal of the last PV module, a first output and a second output electrically connected to a grid/load, wherein the inverter has a maximum power point tracking (MPPT) function.

In yet another aspect, the present invention relates to a PV module. In one embodiment, the PV module includes N sub-modules, N being an integer greater than two, each sub-module having a positive terminal and a negative terminal, the N sub-modules electrically connected to each other in series such that the negative terminal of any one but the last sub-module is electrically connected to the positive terminal of the immediate next sub-module; and N voltage balancers, each voltage balancer having a first terminal, a second terminal and a third terminal, wherein the second terminal of any one but the last voltage balancer is electrically connected to the third terminal of the immediate next voltage balancer; the third terminal of any one but the last voltage balancer is electrically connected to the first terminal of the immediate next voltage balancer; the first terminal of the first voltage balancer is electrically connected to the positive terminal of the first sub-module; the second and third terminals of the last voltage balancer are electrically connected to a B-out terminal and the negative terminal of the last sub-module, respectively; the third terminal of the j-th voltage balancer is electrically connected to both the negative terminal of the j-th sub-module and the positive terminal of the (j+1)-th sub-module, j=1, 2, 3, . . . , (N−1); and the third terminal of the first voltage balancer is electrically connected to a B-in terminal.

In one embodiment, each voltage balancer has a first switch, S1, and a second switch, S2, electrically coupled between the first terminal and the second terminal; a first diode, D1, and a second diode, D2, each diode electrically coupled to a respective switch in parallel; an inductor, L, electrically coupled between the junction of the first and second switches and the third terminal; and a first capacitor, C1, electrically coupled between the first and third terminals and a second capacitor, C2, electrically coupled between the second and third terminals.

Additionally, each voltage balancer may further include a pulse generator electrically coupled to the first and second switches S1 and S2 for providing one or more driving signals for driving the first and second switches S1 and S2, wherein the one or more driving signals have a compensative 50% duty cycle.

In one embodiment, each voltage balancer also has an enable logic circuit electrically coupled between the pulse generator and the first and third terminals, wherein the enable logic circuit is configured to sense input voltages V1 and V2 such that when the difference between input voltages V1 and V2 is lower than a predetermined threshold, the enable logic circuit disables the pulse generator and turn the voltage balancer off, wherein the input voltages V1 and V2 are voltages at the first and third terminals, respectively.

In one embodiment, each sub-module comprises a plurality of PV cells electrically connected to each other in series.

In a further aspect, the present invention relates to a PV system. In one embodiment, the PV system comprises a plurality of PV modules, each PV module as set forth above, the plurality of PV modules electrically connected to each other such that the negative terminal and the B-out terminal of any one but the last PV module is electrically connected to the positive terminal and the B-in terminal of the immediate next PV module, respectively; and an inverter having a first input electrically connected to the positive terminal of the first PV module, a second input electrically connected to the negative terminal of the last PV module, a first output and a second output electrically connected to a grid/load, wherein the inverter has an MPPT function.

In yet a further aspect, the present invention relates to a PV system. In one embodiment, the PV system includes a plurality of PV modules, each PV module having a positive terminal and a negative terminal, the plurality of PV modules electrically connected to each other in series such that the negative terminal of any one but the last PV module is electrically connected to the positive terminal of the immediate next PV module; one or more voltage balancers, each voltage balancer having a first terminal, a second terminal and a third terminal; and an inverter having a first input electrically connected to the positive terminal of the first PV module, a second input electrically connected to the negative terminal of the last PV module, a first output and a second output electrically connected to a grid/load, wherein the inverter has an MPPT function.

In one embodiment, each voltage balancer has a first switch, S1, and a second switch, S2, electrically coupled between the first terminal and the second terminal; a first diode, D1, and a second diode, D2, each diode electrically coupled to a respective switch in parallel; an inductor, L, electrically coupled between the junction of the first and second switches and the third terminal; and a first capacitor, C1, electrically coupled between the first and third terminals and a second capacitor, C2, electrically coupled between the second and third terminals.

Additionally, each voltage balancer may further include a pulse generator electrically coupled to the first and second switches S1 and S2 for providing one or more driving signals for driving the first and second switches S1 and S2, wherein the one or more driving signals have a compensative 50% duty cycle.

In one embodiment, each voltage balancer also has an enable logic circuit electrically coupled between the pulse generator and the first and third terminals, wherein the enable logic circuit is configured to sense input voltages V1 and V2 such that when the difference between input voltages V1 and V2 is lower than a predetermined threshold, the enable logic circuit disables the pulse generator and turn the voltage balancer off, wherein the input voltages V1 and V2 are voltages at the first and third terminals, respectively.

In one embodiment, each sub-module comprises a plurality of PV cells electrically connected to each other in series.

In one embodiment, each PV module comprises a plurality of sub-modules electrically connected to each other in series, each sub-module comprising a plurality of PV cells electrically connected to each other in series.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 shows schematically a photovoltaic (PV) module according to one embodiment of the present invention;

FIG. 2 shows schematically a voltage balancer utilized in a PV module according to one embodiment of the present invention;

FIG. 3 shows schematically a voltage balancer utilized in a PV module according to another embodiment of the present invention;

FIG. 4 shows schematically a PV module according to one embodiment of the present invention;

FIG. 5 shows schematically a DC/DC converter utilized in a PV module according to one embodiment of the present invention;

FIG. 6 shows schematically a PV system including a plurality of PV modules according to one embodiment of the present invention;

FIG. 7 shows schematically a PV module according to one embodiment of the present invention;

FIG. 8 shows schematically a PV system including a plurality of PV modules according to one embodiment of the present invention;

FIG. 9 shows schematically a PV system including a plurality of PV modules according to another embodiment of the present invention; and

FIG. 10 shows schematically a conventional PV module.

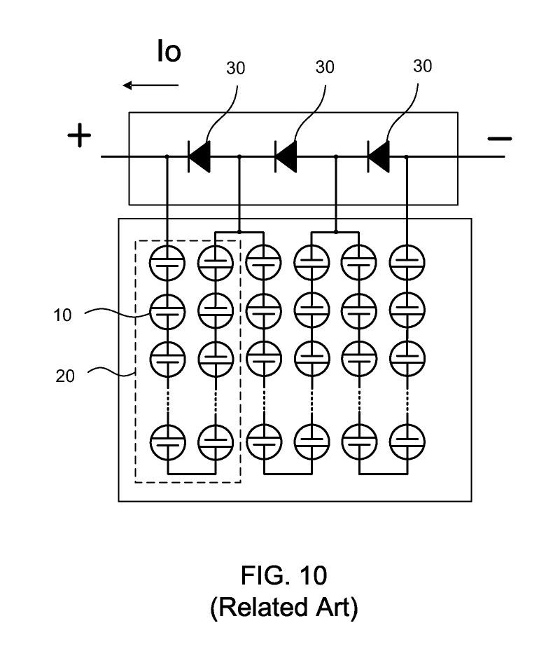

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

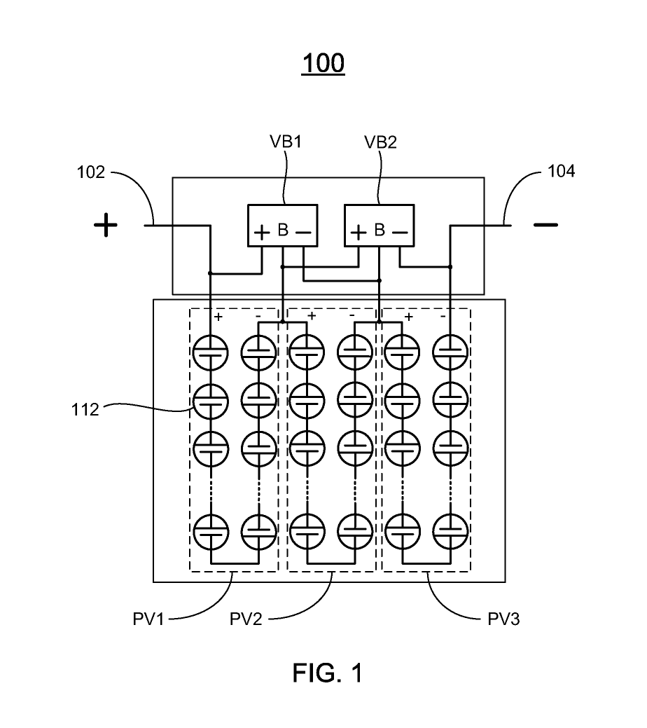

The description will be made as to the embodiments of the present invention in conjunction with the accompanying drawings in FIGS. 1-9. In accordance with the purposes of this invention, as embodied and broadly described herein, this invention, in one aspect, relates to a PV module that utilizes one or more voltage balancers to balance the output voltages of PV sub-modules thereof and applications of same.

Referring to FIG. 1, a PV module 100 is shown according to one embodiment of the present invention. The PV module 100 has a first output port 102 with a positive polarity (+) and a second output port 104, with a negative polarity (−). The PV module 100 includes N sub-modules, {PVj}, j=2, 3, 4, . . . , N, N being an integer greater than one. Each sub-module PVj includes a plurality of PV cells electrically connected to each other in series, thereby having a positive terminal (+) at one end and a negative terminal (−) at the other end. The N sub-modules {PVj} are electrically connected to each other in series such that the negative terminal (−) of any one but the last sub-module is electrically connected to the positive terminal (+) of the immediate next sub-module. In this exemplary embodiment shown in FIG. 1, N=3. The negative terminal (−) of the first sub-module PV(1) is electrically connected to the positive terminal (+) of the second sub-module PV(2); and the negative terminal (−) of the second sub-module PV2 is electrically connected to the positive terminal (+) of the third sub-module PV3. The positive terminal (+) of the first sub-module PV1 is electrically connected to the first output port 102 of the PV module 100, while the negative terminal (−) of the third sub-module PV3 is electrically connected to the second output port 104 of the PV module 100.

The PV module 100 also includes (N−1) voltage balancers, {VBk}, k=1, 2, 3, . . . , (N−1). Each voltage balancer VBk has a first terminal (+), a second terminal (−) and a third terminal (B). The second terminal (−) of any one but the last voltage balancer is electrically connected to the third terminal (B) of the immediate next voltage balancer. The third terminal (B) of any one but the last voltage balancer is electrically connected to the first terminal (+) of the immediate next voltage balancer. Further, the first terminal (+) of the first voltage balancer VB1 is electrically connected to the positive terminal (+) of the first sub-module PV1. The second terminal (−) of the last voltage balancer VB(N−1) is electrically connected to the negative terminal (−) of the last sub-module PVN. The third terminal (B) of the k-th voltage balancer VBk is electrically connected to both the negative terminal (−) of the k-th sub-module PVk and the positive terminal (+) of the (k+1)-th sub-module PV(k+1).

For example, as shown in FIG. 1, the second terminal (−) of the first voltage balancer VB 1 is electrically connected to the third terminal (B) of the second voltage balancer VB2; and the third terminal (B) of the first voltage balancer VB1 is electrically connected to the first terminal (+) of the second voltage balancer VB2. Further, the first terminal (+) of the first voltage balancer VB1 is electrically connected to the positive terminal (+) of the first sub-module PV1. The second terminal (−) of the second voltage balancer VB2 is electrically connected to the negative terminal (−) of the third sub-module PV3. The third terminal (B) of the first voltage balancer VB1 is electrically connected to both the negative terminal (−) of the first sub-module PV1 and the positive terminal (+) of the second sub-module PV2. The third terminal (B) of the second voltage balancer VB2 is electrically connected to both the negative terminal (−) of the second sub-module PV2 and the positive terminal (+) of the third sub-module PV3. The VB1 provides balancing function for PV1 and PV2, and the VB2 provides balancing function for PV2 and PV3.

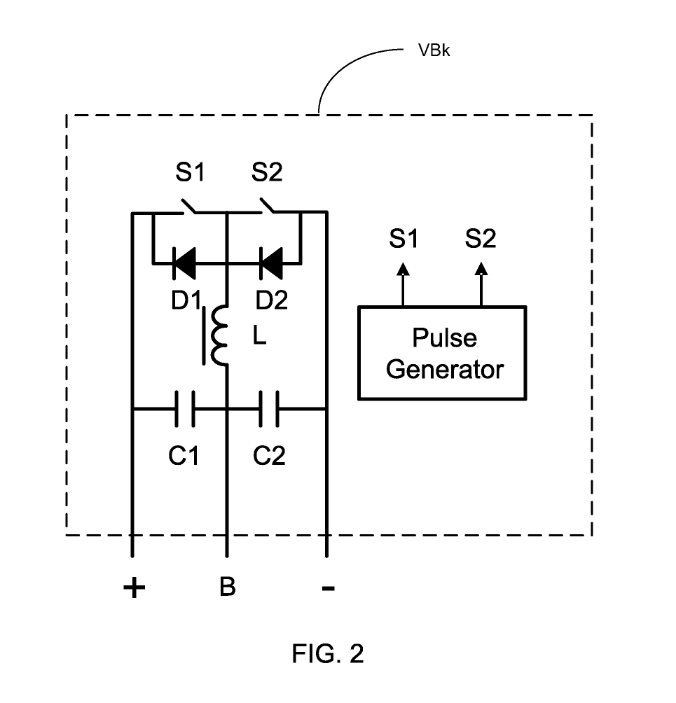

Referring to FIG. 2, in one embodiment, each voltage balancer VBk has a first switch S1, a second switch S2, a first diode D1, a second diode D2, an inductor L, a first capacitor C1 and a second capacitor C2. The first switch S1 and the second switch S2 are electrically coupled between the first terminal (+) and the second terminal (−). The first and second switches S1 and S2 can be any types of switches, for example, thin film transistors (TFTs). Each of the first diode D1 and the second diode D2 is electrically coupled to a respective switch in parallel. The inductor L is electrically coupled between the junction of the first and second switches S1 and S2 and the third terminal (B). The first capacitor C1 is electrically coupled between the first terminal (+) and the third terminal (B). The second capacitor C2 is electrically coupled between the second terminal (−) and the third terminal (B). The first and second capacitors C1 and C2 provide the filtering function to prevent the switching frequency ripple current from passing through the sub-modules {PVk}.

Additionally, each voltage balancer VBk also has a pulse generator electrically coupled to the first and second switches S1 and S2 for providing one or more driving signals with a compensative 50% duty cycle for driving the first and second switches S1 and S2. The voltage balancer VBk provides the balancer function for the sub-modules {PVk} connected to it.

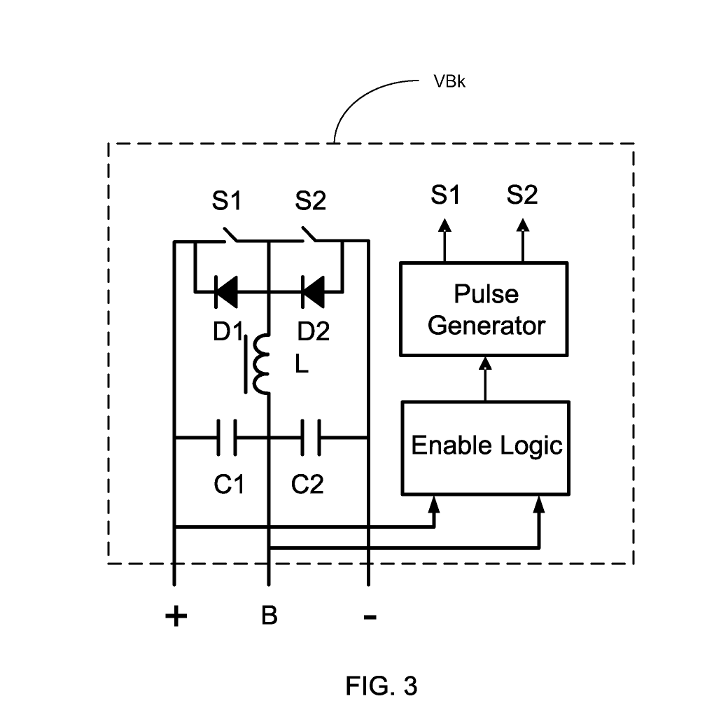

In one embodiment shown in FIG. 3, each voltage balancer VBk further includes an enable logic circuit electrically coupled between the pulse generator and the first terminal (+) and the third terminal (B). The enable logic circuit determines the voltage balancer VBk to be turned on or off. The enable logic circuit is configured to sense input voltages V1 and V2 such that when the difference of the input voltages V1 and V2 is lower than a predetermined threshold, the enable logic circuit disables the pulse generator and turn off the voltage balancer VBk. The input voltages V1 and V2 are voltages at the first terminal (+) and the third terminal (B), respectively, and output from the corresponding sub-modules PVk and PV(k+1), respectively, coupled to the voltage balancer VBk.

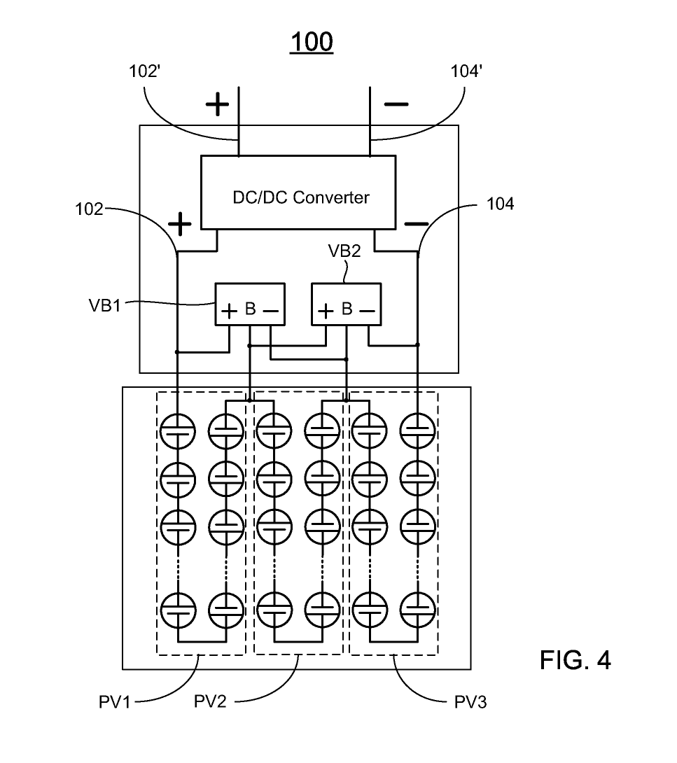

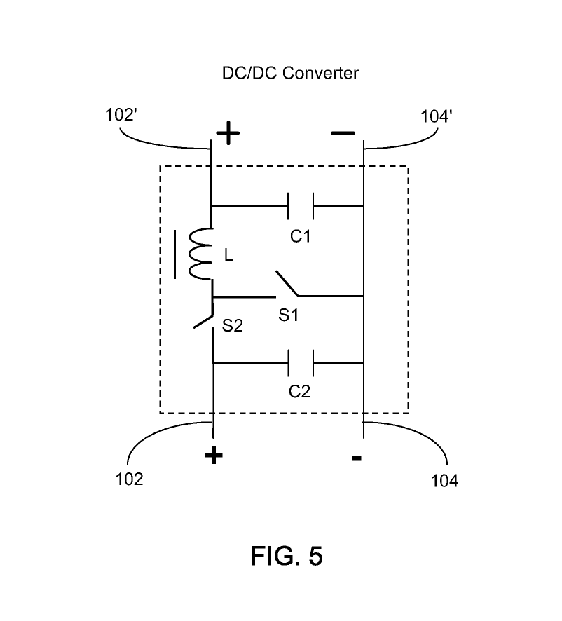

For such a configuration, if one sub-module is partially shaded, the current output from the sub-module may decrease, however, the voltages V1 and V2 keep the same because of the voltage balancer VBk. The PV module 100 enables each sub-module PVk to operate close to the maximal output power, even in a partial shading condition. Referring to FIGS. 4 and 5, the PV module 100 in one embodiment further includes a DC/DC converter. The voltage balancer {VBk} are used to keep the voltage balance of all sub-modules {PVj}, while the DC/DC converter is adapted for tracking the maximal output power of the PV module 100. As shown in FIG. 5, the DC/DC converter has a positive input port 102, a negative input port 104, a positive output port 102′ and a negative output port 104′. The positive and negative input ports 102 and 104 are electrically coupled to the positive terminal (+) of the first sub-module PV1 and the negative terminal (−) of the fourth (last) sub-module PV4, respectively. The DC/DC converter includes a pair of switches S1 and S2 electrically connected between the positive and negative input ports 102 and 104; an inductor L electrically coupled between the positive output port 102′ and the junction of the pair of switches S1 and S2; and a pair of capacitors C1 and C2. One capacitor C1 is electrically coupled between the positive and negative input ports 102 and 104, and the other capacitor C2 is electrically coupled between the positive and negative output ports 102′ and 104′. The negative output port 104′ is electrically connected to the negative input port 104.

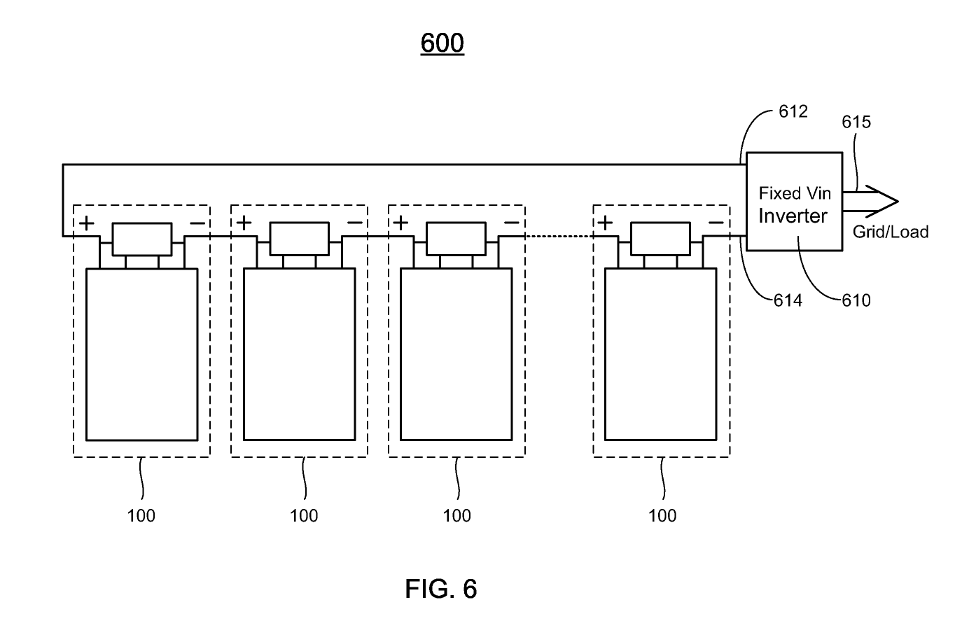

FIG. 6 shows schematically a PV system 600 that includes a plurality of PV modules 100 as defined above. The plurality of PV modules 100 is electrically connected to each other in series such that the negative terminal (−) of any one but the last PV module 100 is electrically connected to the positive terminal (+) of the immediate next PV module 100.

The PV system 600 also includes an inverter 610 having a first input port 612 electrically connected to the positive terminal (+) of the first PV module 100, a second input port 614 electrically connected to the negative terminal (−) of the last PV module 100. The inverter 610 has an output port 615 for outputting the power to a grid/load. The inverter 610 has a maximum power point tracking (MPPT) function for optimizing the power output of the PV system 600.

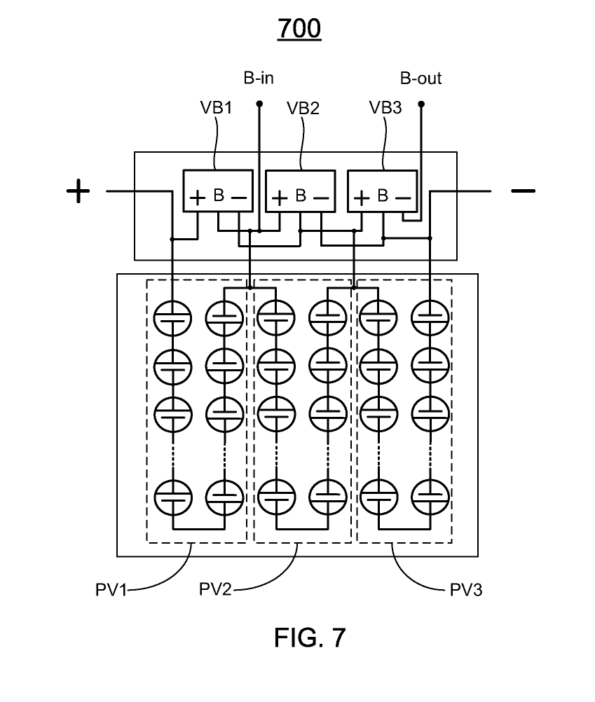

Referring to FIG. 7, a PV module 700 is schematically shown according to one embodiment of the present invention. The PV module 700 is substantially similar to the PV module 100 as shown in FIGS. 1-5, except that the PV module 700 has a B-in terminal and a B-out terminal, and includes N voltage balancers {VBk}, k=1, 2, 3, . . . , N. The second terminal (−) of any one but the last voltage balancer is electrically connected to the third terminal (B) of the immediate next voltage balancer. The third terminal (B) of any one but the last voltage balancer is electrically connected to the first terminal (+) of the immediate next voltage balancer. The first terminal (+) of the first voltage balancer is electrically connected to the positive terminal (+) of the first sub-module PV 1. The second terminal (−) and the third terminal (B) of the last voltage balancer are electrically connected to the B-out terminal and the negative terminal (−) of the last sub-module PVN, respectively. The third terminal (B) of the j-th voltage balancer is electrically connected to both the negative terminal (−) of the j-th sub-module and the positive terminal of the (j+1)-th sub-module, j=1, 2, 3, . . . , (N−1). The third terminal (B) of the first voltage balancer PV1 is electrically connected to the B-in terminal.

For the PV module 700, the first, second and third voltage balancers VB1, VB2 and VB3 are used to balance the voltages of the three sub-modules PV1, PV2 and PV3, while the third voltage balancer VB3 is adapted for keeping the voltage balance between the second sub-module PV2 of the PV module 700 and the first sub-module PV1 of the immediately next PV module in a PV system.

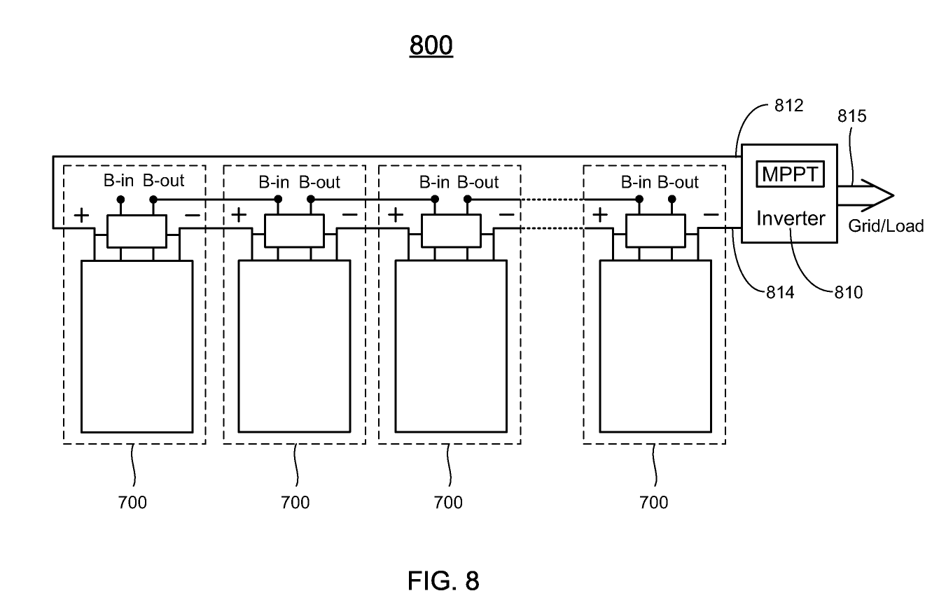

FIG. 8 shows schematically one embodiment of a PV system 800 that has a plurality of PV modules 700 as set forth above. The plurality of PV modules 700 is electrically connected to each other such that the negative terminal (−) and the B-out terminal of any one but the last PV module are electrically connected to the positive terminal (+) and the B-in terminal of the immediate next PV module, respectively.

The PV system 800 also includes an inverter 810 having a first input port 812 electrically connected to the positive terminal (+) of the first PV module 100, a second input port 814 electrically connected to the negative terminal (−) of the last PV module 100. The inverter 810 has an output port 815 for outputting the power to a grid or a load. The inverter 810 has an MPPT function for optimizing the power output of the PV system 800.

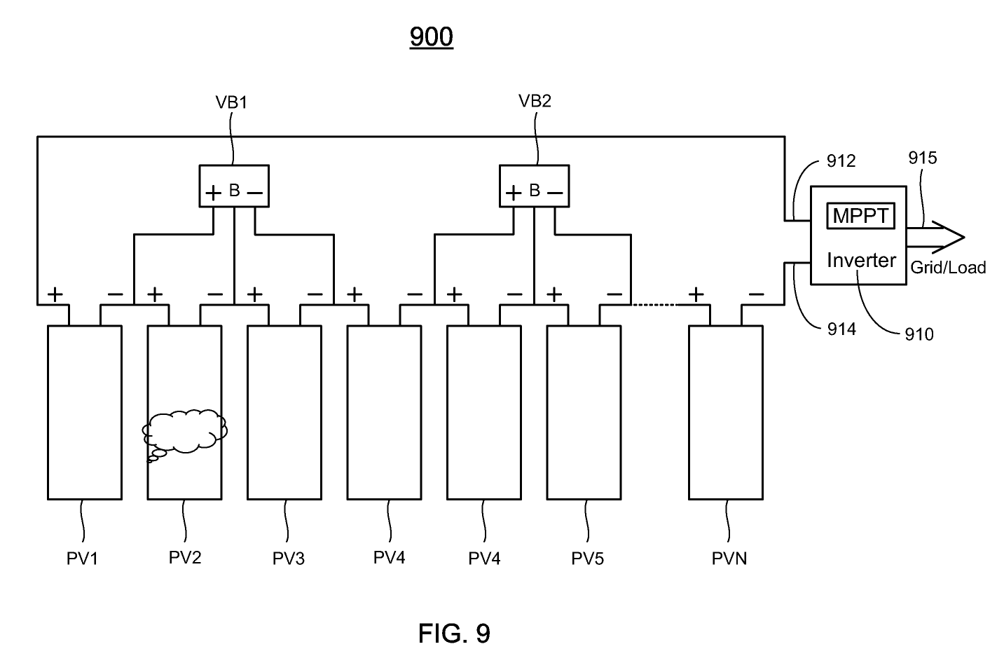

Referring to FIG. 9, a PV system 900 is schematically shown according to one embodiment of the present invention. The PV system includes a plurality of PV modules {PVj}, j=1, 2, 3, . . . , N. Each PV module PVj has a positive terminal (+) and a negative terminal (−). The plurality of PV modules {PVj} is electrically connected to each other in series such that the negative terminal (−) of any one but the last PV module is electrically connected to the positive terminal (+) of the immediate next PV module.

In this exemplary embodiment shown in FIG. 9, the PV system 900 also has two voltage balancers VB1 and VB2. Each voltage balancer has a first terminal (+), a second terminal (−) and a third terminal (B). The first terminal (+) of the first voltage balancer VB 1 is electrically connected to the junction node of the first PV module PV 1 and the second PV module PV2; the third terminal (B) of the first voltage balancer VB1 is electrically connected to the junction node of the second PV module PV2 and the third PV module PV3; and the second terminal (−) of the first voltage balancer VB1 is electrically connected to the junction node of the third PV module PV3 and the fourth PV module PV4. Accordingly, the first voltage balancer VB1 is used to balance the voltages of the PV modules PV2 and PV3. Similarly, the second voltage balancer VB2 is used to balance the voltages of the PV modules PV4 and PV5. In this exemplary embodiment, the PV modules PV2 is shaded.

Further, the PV system 900 includes an inverter 910 having a first input port 912 electrically connected to the positive terminal (+) of the first PV module 100, a second input port 914 electrically connected to the negative terminal (−) of the last PV module 100. The inverter 910 has an output port 915 for outputting the power to a grid or a load. The inverter 910 has an MPPT function for optimizing the power output of the PV system 900.

In sum, the present invention, among other things, recites a PV module that utilizes one or more voltage balancers to balance the output voltages of PV sub-modules thereof and applications of same.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A photovoltaic (PV) module, comprising:
(a) N sub-modules, N being an integer greater than one, each sub-module having a positive terminal and a negative terminal, the N sub-modules electrically connected to each other in series such that the negative terminal of any one but the last sub-module is electrically connected to the positive terminal of the immediate next sub-module; and
(b) N−1 voltage balancers, each voltage balancer having a first terminal, a second terminal and a third terminal, wherein
the second terminal of any one but the last voltage balancer is electrically connected to the third terminal of the immediate next voltage balancer;
the third terminal of any one but the last voltage balancer is electrically connected to the first terminal of the immediate next voltage balancer;
the first terminal of the first voltage balancer is electrically connected to the positive terminal of the first sub-module;
the second terminal of the last voltage balancer is electrically connected to the negative terminal of the last sub-module; and
the third terminal of the j-th voltage balancer is electrically connected to both the negative terminal of the j-th sub-module and the positive terminal of the (j+1)-th sub-module, j=1, 2, 3, . . . , (N−1).

2. The PV module of claim 1, wherein each voltage balancer comprises:
(a) a first switch, S1, and a second switch, S2, electrically coupled between the first terminal and the second terminal;
(b) a first diode, D1, and a second diode, D2, each diode electrically coupled to a respective switch in parallel;
(c) an inductor, L, electrically coupled between the junction of the first and second switches and the third terminal; and
(d) a first capacitor, C1, electrically coupled between the first and third terminals and a second capacitor, C2, electrically coupled between the second and third terminals.

3. The PV module of claim 2, wherein each voltage balancer further comprises a pulse generator electrically coupled to the first and second switches S1 and S2 for providing one or more driving signals for driving the first and second switches S1 and S2, wherein the one or more driving signals have a compensative 50% duty cycle.

4. The PV module of claim 3, wherein each voltage balancer further comprises an enable logic circuit electrically coupled between the pulse generator and the first and third terminals, wherein the enable logic circuit is configured to sense input voltages V1 and V2 such that when the difference between input voltages V1 and V2 is lower than a predetermined threshold, the enable logic circuit disables the pulse generator and turn the voltage balancer off, wherein the input voltages V1 and V2 are voltages at the first and third terminals, respectively.

5. The PV module of claim 1, further comprising a DC/DC converter having a positive input, a negative input, a positive output and a negative output, wherein the positive and negative inputs are electrically coupled to the positive terminal of the first sub-module and the negative terminals of the last sub-module, respectively.

6. The PV module of claim 5, wherein the DC/DC converter comprises:
(a) a pair of switches electrically connected between the positive and negative terminals;
(b) an inductor electrically coupled between the positive output and the junction of the pair of switches; and
(c) a pair of capacitors, one capacitor electrically coupled between the positive and negative inputs, and the other electrically coupled between the positive and negative outputs,
wherein the negative output is electrically connected to the negative input.

7. The PV module of claim 1, wherein each sub-module comprises a plurality of PV cells electrically connected to each other in series.

8. A PV system, comprising:
(a) a plurality of PV modules, each PV module defined in claim 1, the plurality of PV modules electrically connected to each other in series such that the negative terminal of any one but the last PV module is electrically connected to the positive terminal of the immediate next PV module; and
(b) an inverter having a first input electrically connected to the positive terminal of the first PV module, a second input electrically connected to the negative terminal of the last PV module, a first output and a second output electrically connected to a grid or a load, wherein the inverter has a maximum power point tracking (MPPT) function.

9. A photovoltaic (PV) module, comprising:
(a) N sub-modules, N being an integer greater than two, each sub-module having a positive terminal and a negative terminal, the N sub-modules electrically connected to each other in series such that the negative terminal of any one but the last sub-module is electrically connected to the positive terminal of the immediate next sub-module; and
(b) N voltage balancers, each voltage balancer having a first terminal, a second terminal and a third terminal, wherein
the second terminal of any one but the last voltage balancer is electrically connected to the third terminal of the immediate next voltage balancer;
the third terminal of any one but the last voltage balancer is electrically connected to the first terminal of the immediate next voltage balancer;
the first terminal of the first voltage balancer is electrically connected to the positive terminal of the first sub-module;
the second and third terminals of the last voltage balancer are electrically connected to a B-out terminal and the negative terminal of the last sub-module, respectively;
the third terminal of the j-th voltage balancer is electrically connected to both the negative terminal of the j-th sub-module and the positive terminal of the (j+1)-th sub-module, j=1, 2, 3, . . . , (N−1); and
the third terminal of the first voltage balancer is electrically connected to a B-in terminal.

10. The PV module of claim 9, wherein each voltage balancer comprises:
(a) a first switch, S1, and a second switch, S2, electrically coupled between the first terminal and the second terminal;
(b) a first diode, D1, and a second diode, D2, each diode electrically coupled to a respective switch in parallel;
(c) an inductor, L, electrically coupled between the junction of the first and second switches and the third terminal; and
(d) a first capacitor, C1, electrically coupled between the first and third terminals and a second capacitor, C2, electrically coupled between the second and third terminals.

11. The PV module of claim 10, wherein each voltage balancer further comprises a pulse generator electrically coupled to the first and second switches S1 and S2 for providing one or more driving signals for driving the first and second switches S1 and S2, wherein the one or more driving signals have a compensative 50% duty cycle.

12. The PV module of claim 11, wherein each voltage balancer further comprises an enable logic circuit electrically coupled between the pulse generator and the first and third terminals, wherein the enable logic circuit is configured to sense input voltages V1 and V2 such that when the difference between input voltages V1 and V2 is lower than a predetermined threshold, the enable logic circuit disables the pulse generator and turn the voltage balancer off, wherein the input voltages V1 and V2 are voltages at the first and third terminals, respectively.

13. The PV module of claim 9, wherein each sub-module comprises a plurality of PV cells electrically connected to each other in series.

14. A PV system, comprising:
(a) a plurality of PV modules, each PV module defined in claim 9, the plurality of PV modules electrically connected to each other such that the negative terminal and the B-out terminal of any one but the last PV module are electrically connected to the positive terminal and the B-in terminal of the immediate next PV module, respectively; and
(b) an inverter having a first input electrically connected to the positive terminal of the first PV module, a second input electrically connected to the negative terminal of the last PV module, a first output and a second output electrically connected to a grid or a load, wherein the inverter has a maximum power point tracking (MPPT) function.

15. A PV system, comprising:
(a) a plurality of PV modules, each PV module having a positive terminal and a negative terminal, the plurality of PV modules electrically connected to each other in series such that the negative terminal of any one but the last PV module is electrically connected to the positive terminal of the immediate next PV module;
(b) one or more voltage balancers, each voltage balancer having a first terminal, a second terminal and a third terminal coupled to respective PV modules for balance voltages of the respective PV modules; and
(c) an inverter having a first input electrically connected to the positive terminal of the first PV module, a second input electrically connected to the negative terminal of the last PV module, a first output and a second output electrically connected to a grid or a load, wherein the inverter has a maximum power point tracking (MPPT) function.

16. The PV module of claim 15, wherein each voltage balancer comprises:
(a) a first switch, S1, and a second switch, S2, electrically coupled between the first terminal and the second terminal;
(b) a first diode, D1, and a second diode, D2, each diode electrically coupled to a respective switch in parallel;
(c) an inductor, L, electrically coupled between the junction of the first and second switches and the third terminal; and
(d) a first capacitor, C1, electrically coupled between the first and third terminals and a second capacitor, C2, electrically coupled between the second and third terminals.

17. The PV module of claim 16, wherein each voltage balancer further comprises a pulse generator electrically coupled to the first and second switches S1 and S2 for providing one or more driving signals for driving the first and second switches S1 and S2, wherein the one or more driving signals have a compensative 50% duty cycle.

18. The PV module of claim 17, wherein each voltage balancer further comprises an enable logic circuit electrically coupled between the pulse generator and the first and third terminals, wherein the enable logic circuit is configured to sense input voltages V1 and V2 such that when the difference between input voltages V1 and V2 is lower than a predetermined threshold, the enable logic circuit disables the pulse generator and turn the voltage balancer off, wherein the input voltages V1 and V2 are voltages at the first and third terminals, respectively.

19. The PV module of claim 15, wherein each PV module comprises a plurality of sub-modules electrically connected to each other in series, each sub-module comprising a plurality of PV cells electrically connected to each other in series.
